(19) United States
(12) Patent Application Publication
(10) Pub. No.: US 2010/0328942 A1
(43) Pub. Date: Dec. 30, 2010

(54) Ceramic radiator with conductive circuit

(76) Inventor: Te-Lung Chen, Tainan (TW)

Correspondence Address: Te-Lung, Chen, No. 2, Alley 492, Sec. 2, Hai Tien Rd., Tainan, 709, TW

(21) Appl. No.: 12/661,204

(22) Filed: Mar. 15, 2010

(30) Foreign Application Priority Data
Jun. 29, 2009 (TW) 098211651

(51) Int. Cl. F21V 1/00

(52) U.S. Cl. 362/235

(57) ABSTRACT

A ceramic radiator with conductive circuit uses the ceramic with high conductive ceramic and better radiation physical characteristics to manufacture the one-body-shaped radiator. The radiator has front side, back side and ends. The conductive circuit is set on the front side of the radiator to enable one or more LED lights installed thereon lightened. Several sets of the heat sinks are installed on the back side and the ends to increase the efficiency of heat dissipating. A lamp mask covers the LED lights. The ceramic radiator may remove its lamp mask when placed indoors.

### BACKGROUND OF THE INVENTION

1. Field of the Invention

This invention is related with the ceramic radiator with conductive circuit, it uses the ceramic which has high conductivity, and moreover, with better radiation physical characteristics to manufacture the radiator, wherein the conductive circuit is set on the front side of the radiator to enable one or more sets of the LED lights installed thereon lightened, so thus the heat of the LED lights would be quickly dissipated through the ceramic radiator to keep the lights in lower temperature and avoid rapid damage by the increasing temperature.

2. Description of the Related Art

As the growing phenomenon of global warming, places all over the world appeal to save energy and reduce carbon; environmental protection has become an important topic in daily life, thus the related products are also receiving increasing attention, especially for the use of the light bulbs. Therefore, lots of LED lights taking the place of the light bulbs. However, lighting the LED lights may cause heat, and the radiators recently are still made from copper, aluminum or other alloy. Low efficiency of the heat dissipating may cause the high temperature, and increasing equipment of the radiator module would not achieve the objective to save the cost and the energy.

For the reasons mentioned above, some use semi-conducting thermoelectric cooling member to increase the efficiency of heat dissipating. “The Ceramic Semi-conducting Thermoelectric Cooling LED light”, which is the prior invention, is published as No. M351993 in Taiwan patent as shown in FIG. 1, the prior invention comprises an LED light (70), a semi-conducting thermoelectric cooling member (71), a conductive circuit (72) and a radiator module (73). The semi-conducting thermoelectric cooling member (71) is made from ceramic. The conductive circuit (72) laying with metal film like nickel plating and tin is on top of the ceramic with silver circuit set thereon to provide LED light the electric current and thus enable it lightened. The radiator module (73) made from aluminum is connected on the other side of the ceramic.

However, the prior invention mentioned above has the following shortcoming:

The heat caused from the LED light (70) of the prior invention conducts to the semi-conducting thermoelectric cooling member (71) through the conductive circuit (72), and the heat is dissipated together with the radiator module (73) connected on the side of the semi-conducting thermoelectric cooling member (71). However, the physical coefficient such as the thermal conductivity coefficient, the coefficient of thermal radiation and the specific heat, etc. of the radiator module (73) is inconsistent with the semi-conducting thermoelectric cooling member (71), therefore the efficiency of heat dissipating between the two is different. Furthermore, the connecting gaps between each member might reduce the efficiency of the thermal conductivity. Since the semi-conducting thermoelectric cooling member (71) absorbs the heat from the LED light (70), if the heat dissipating of the radiator module (73) slows down, the heat might be gathered in the semi-conducting thermoelectric cooling member (71) and could not be discharged rapidly.

### SUMMARY

The present invention as shown in FIGS. 2 and 3, a ceramic radiator with conductive circuit uses high conductive ceramic, and moreover, with better radiation physical characteristics of the ceramic to manufacture the one-body-shaped radiator. The conductive circuit is set on the front side of the radiator to enable one or more sets of the LED lights installed thereon lightened. Several sets of the heat sinks are installed on the back and the ends to increase the efficiency of heat dissipating. A lamp mask covers the LED lights. The advantages are as following:

Firstly, the LED lights of the present invention are connected with the one-body-shaped radiator. The heat caused from the LED lights is conducted to the radiator through the conductive circuit and dissipated by the ceramic material with high heat conducting and high radiation physical characteristics. Therefore, there would not be the connecting problems of gaps between each member to reduce the efficiency of the thermal conductivity, but it could dissipate the heat steadily and rapidly instead. The ceramic radiator is one-body shaped and there is no need to be fabricated, thus it may reduce the reject ratio of human factors and it would be cost-effective.

Secondly, the radiator made from ceramic material is better than made from metal materials for weather resistance. The ceramic radiator would not be oxidized, therefore the limitation of being used in any environment, such as the beach or the petrochemical plants, may be less.

### BRIEF DESCRIPTION OF THE DRAWINGS

FIG. 1 is a schematic drawing illustrating the prior invention.

FIG. 2 is a schematic drawing illustrating the present invention.

FIG. 3 is a perspective view illustrating the present invention.

FIG. 4 is a schematic drawing illustrating the heat sinks.

FIG. 5 is another schematic drawing illustrating the heat sinks.

FIG. 6 is a schematic drawing illustrating the example of the present invention.

FIG. 7 is a schematic drawing illustrating the second example of the present invention.

FIG. 8 is a schematic drawing illustrating the third example of the present invention.

FIG. 9 is a schematic drawing illustrating the cylindrical dissipating protrusions.

FIG. 10 is a schematic drawing illustrating the cone-shaped dissipating protrusions.

FIG. 11 is a schematic drawing illustrating the square-column-shaped dissipating protrusions.

FIG. 12 is a schematic drawing illustrating the wavy dissipating protrusions.

FIG. 13 is a schematic drawing illustrating the regular bump-like of the heat sinks.

FIG. 14 is a schematic drawing illustrating the irregular bump-like of the heat sinks.

FIG. 15 is a schematic drawing illustrating the hollow cylindrical dissipating protrusions.

FIG. 16 is a schematic drawing illustrating the hollow cone-shaped dissipating protrusions.

FIG. 17 is a schematic drawing illustrating the hollow square-column-shaped dissipating protrusions.

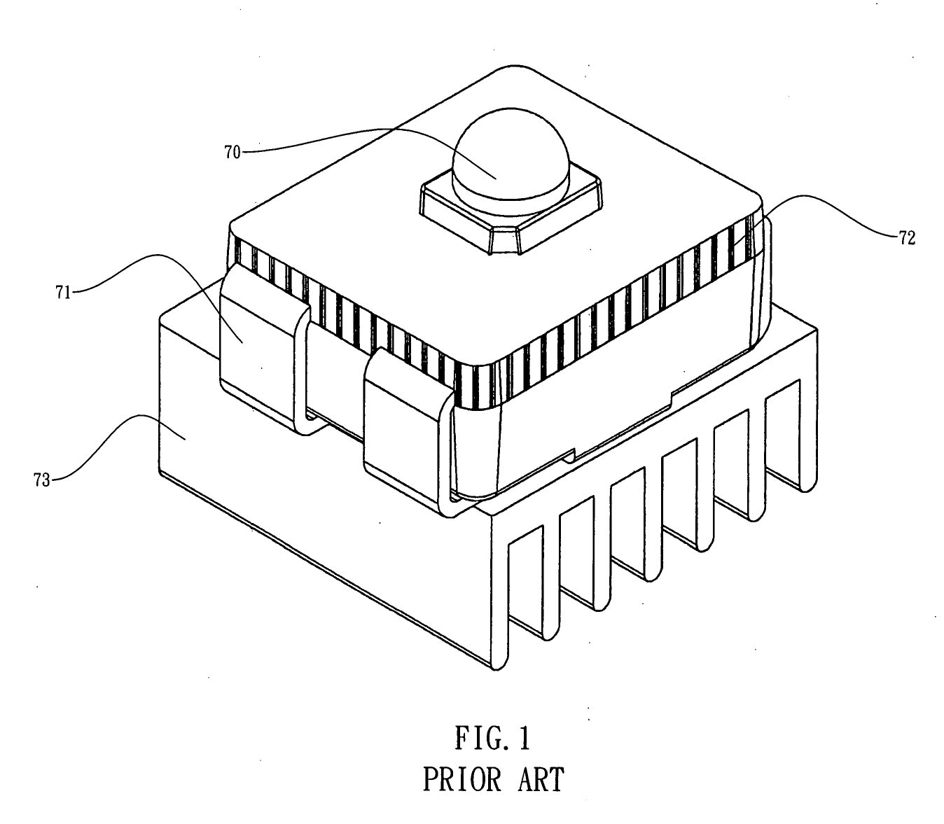

### DETAILED DESCRIPTION OF THE INVENTION

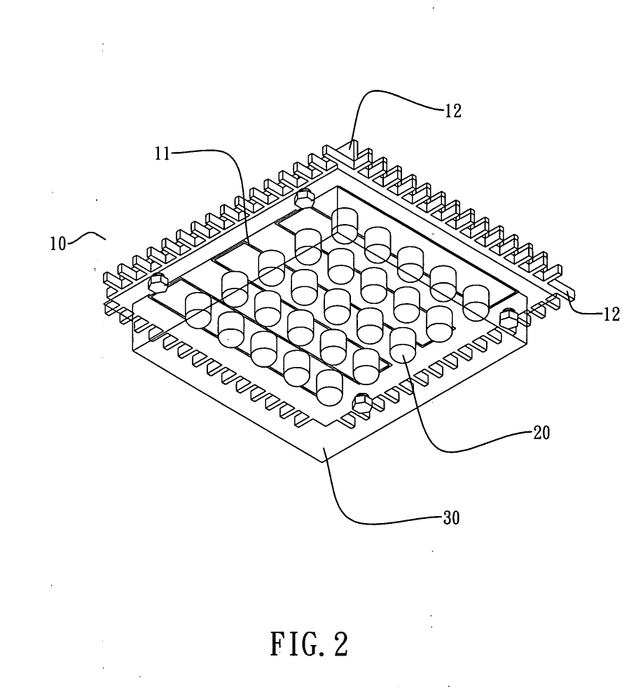

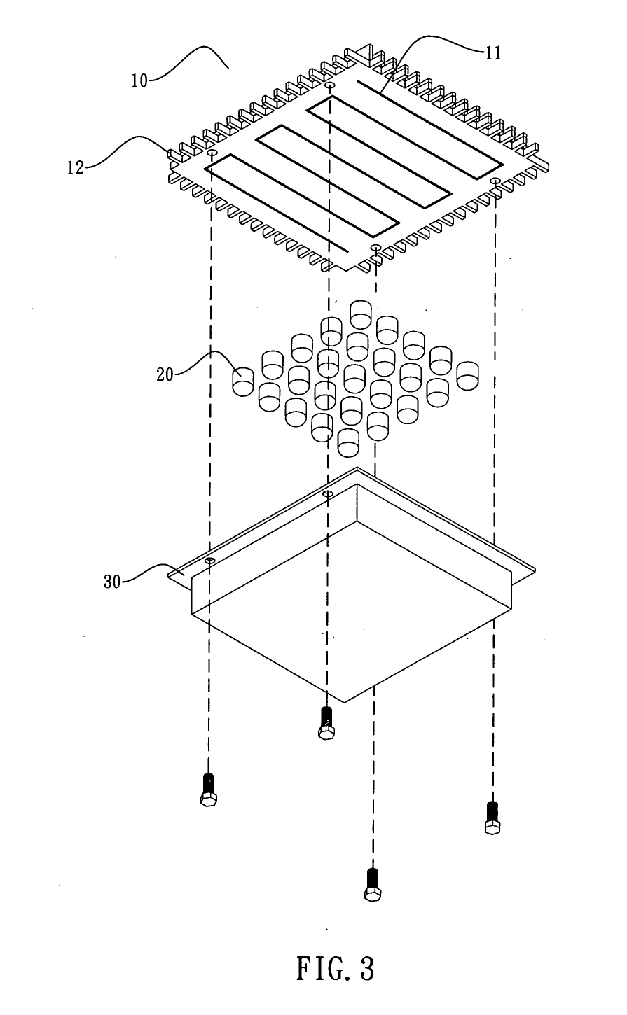

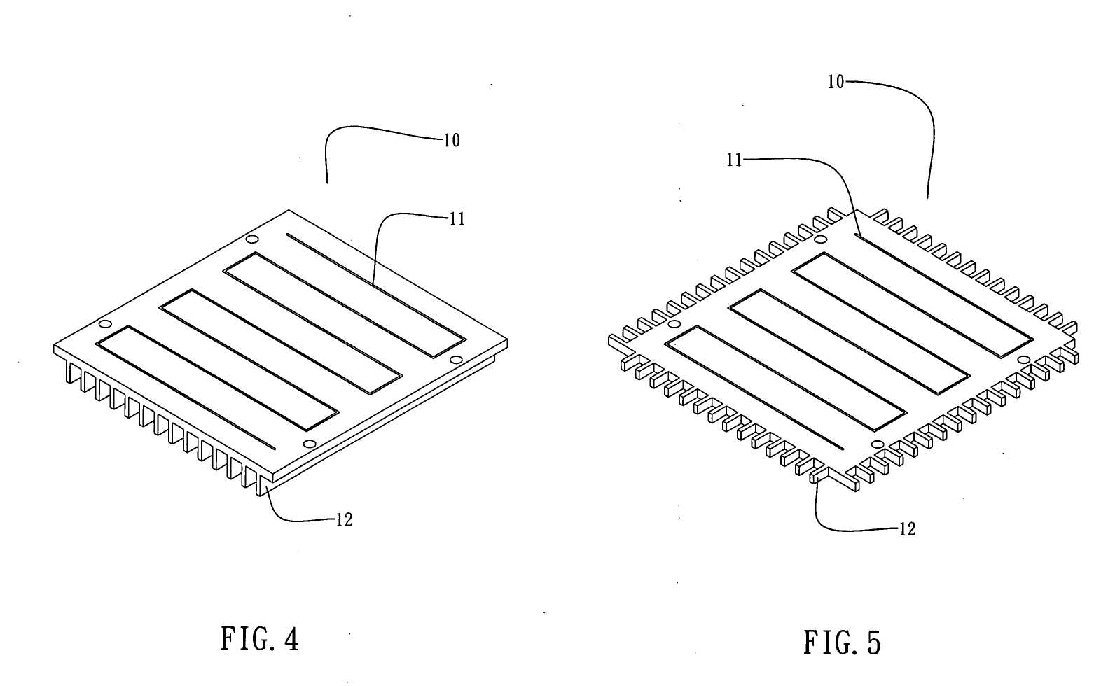

Referring to FIGS. 2 and 3, the ceramic radiator with the conductive circuit is to rapidly absorb and dissipate the heat of the LED lights when being lightened, to ensure the LED lights stay in a status of steadily lightened and low temperature. The present invention comprises a one-body-shaped radiator (10) which uses the ceramic with high conductivity and radiation physical characteristics, wherein the radiator(10) has front side, back side and ends. The conductive circuit (11) is set on the front side of the radiator (10). The conductive circuit (11) laying with metal film such as nickel plating and tin is on top of the silver circuit to provide LED lights (20) the electric power and thus to enable them lightened. The LED lights (20) could be added with lens when it is needed. Several sets of the heat sinks (12) are installed on the back side and the ends to increase the efficiency of heat dissipating. Please refer to FIGS. 4 and 5, the heat sinks (12) may be only installed on the back side or one of the ends. Furthermore, if the area of the heat dissipating on the ceramic is wide enough, there is no need to install the heat sinks (12), the back side and the ends could be designed as smooth surfaces instead.

The LED lights (20) are connected on the conductive circuit (11) and received the electric power through the conductive circuit (11) to be lightened, and a lamp mask (30) fastened with screws covers the LED lights (20).

When the LED lights (20) are lightened and the heat is caused, the heat could be conducted to the radiator (10) through the conductive circuit (11), and it would be dissipated by the ceramic material with high heat conducting and high radiation physical characteristics. Therefore, the LED lights (20) could be kept in lower temperature and avoid rapid damage by the increasing temperature.

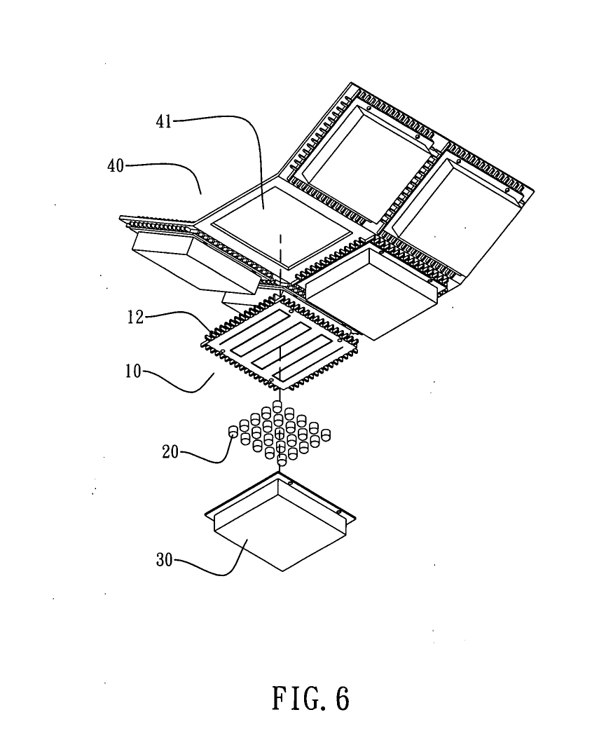

As shown in FIG. 6, this is the first example of the present invention comprising with a frame (40) with several retaining holes (41) thereon, radiators (10), LED lights (20), and a lamp mask (30), wherein install one radiator (10) into each retaining hole (41) respectively and allow the heat sinks (12) out of the retaining holes (41). Install the LED lights (20) on the conductive circuit (11) at the bottom of the radiator (10) to enable the LED lights (20) receive the electric power to be lightened. A lamp mask (30) covers each set of LED lights (20) to form a structure of plurality of radiators.

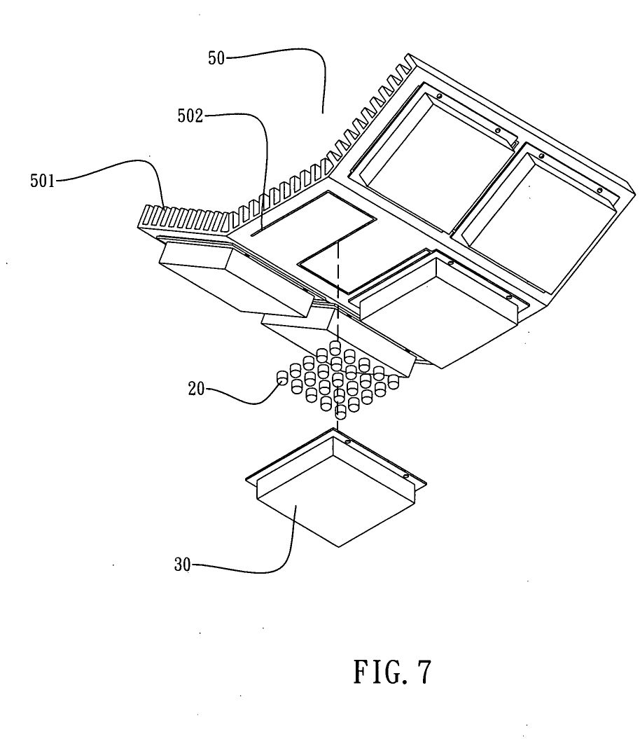

As shown in FIG. 7, this is the second example of the present invention comprising with a ceramic cover (50), LED lights (20), and a lamp mask (30), wherein many sets of the heat sinks (501) are prominent outwardly on top of the ceramic cover (50). A conductive circuit (502) is set at the bottom, and the LED lights (20) are installed on the conductive circuit (502) to enable the LED lights (20) receive the electric power through the conductive circuit (502) to be lightened. A lamp mask (30) covers each set of the LED lights (20). The difference of the example from the other mentioned examples is that, all LED lights (20) and the masks (30) are installed under the ceramic cover (50) to form a single large structure.

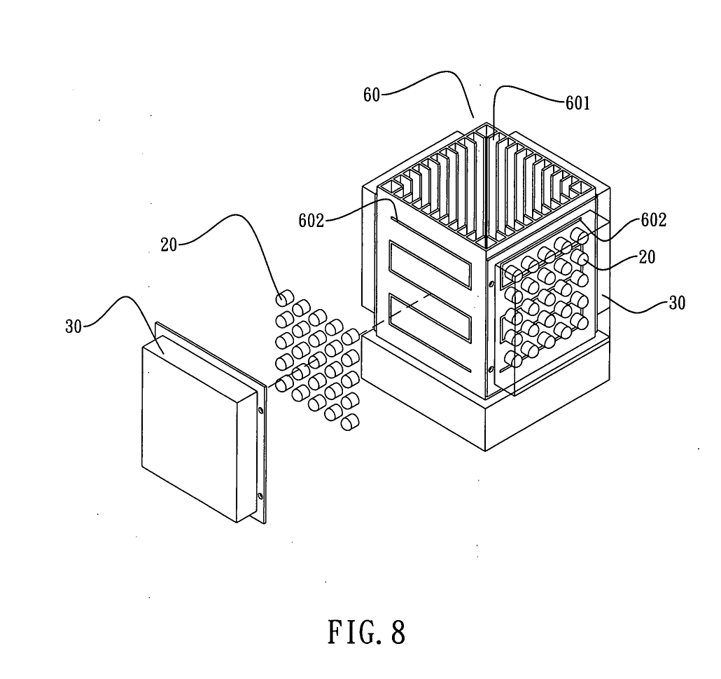

As shown in FIG. 8, this is the third example of the present invention comprising with a long-shaped radiator (60), LED lights (20), and a lamp mask (30), wherein the long-shaped radiator (60) is hollow inside, and one set of the heat sinks (601) is installed on each inside. A conductive circuit (602) is set on each outside, and the LED lights (20) are installed on the conductive circuit (602) to enable the LED lights (20) receive the electric power to be lightened. A lamp mask (30) covers each set of the LED lights (20).

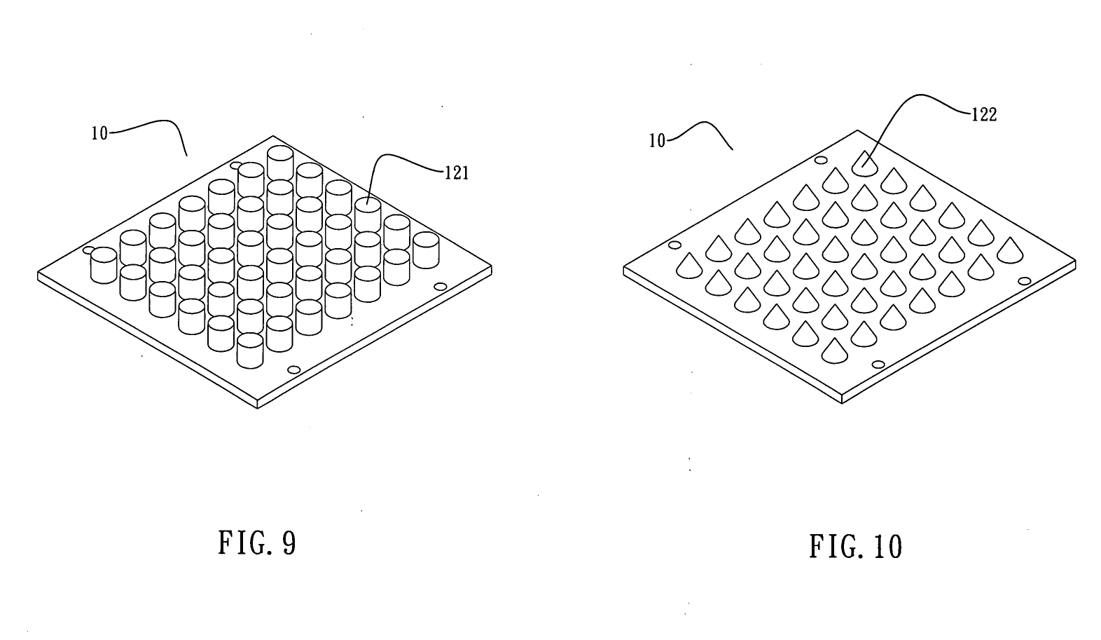

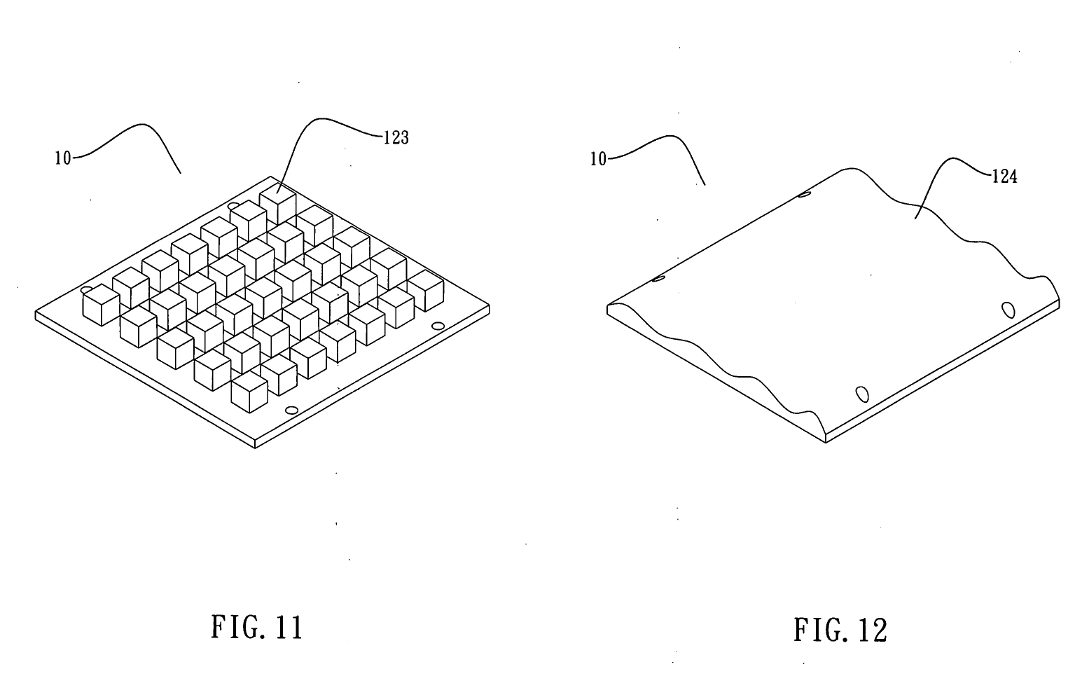

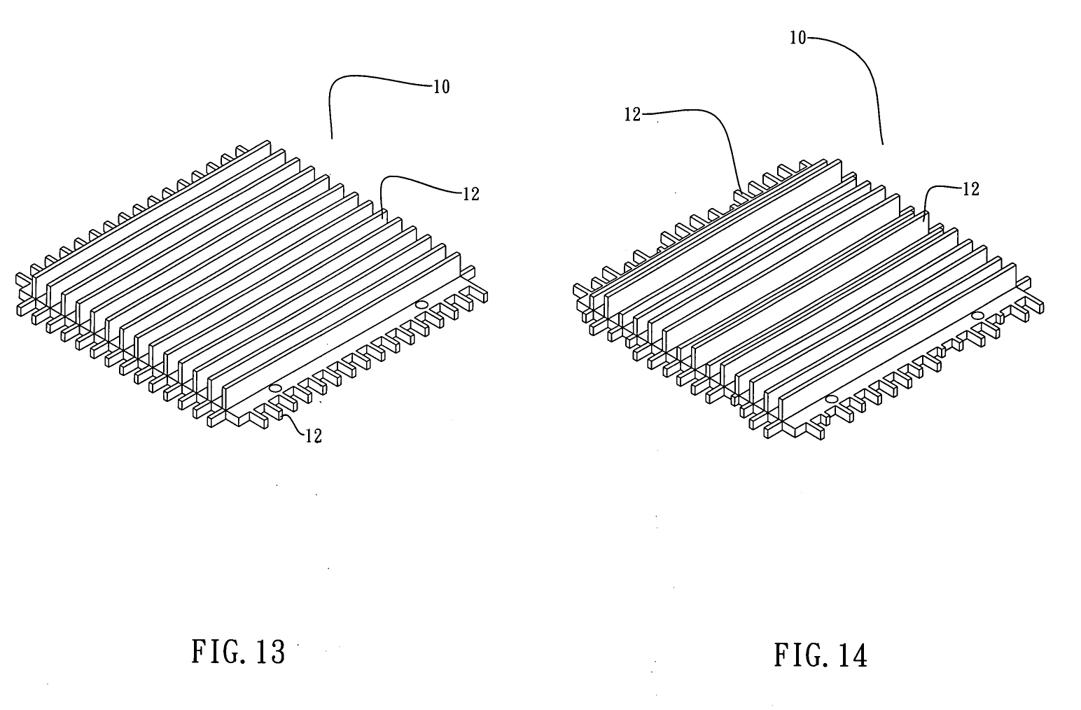

As shown in FIGS. 9-14, the heat sinks (12) and the heat sinks (301, 501, 601) of the radiator (10) mentioned above in the first, second and the third examples can be cylindrical dissipating protrusions (121), cone-shaped dissipating protrusions (122), square-column-shaped dissipating protrusions (123), wavy dissipating protrusions (124), regular bump-like or irregular bump-like.

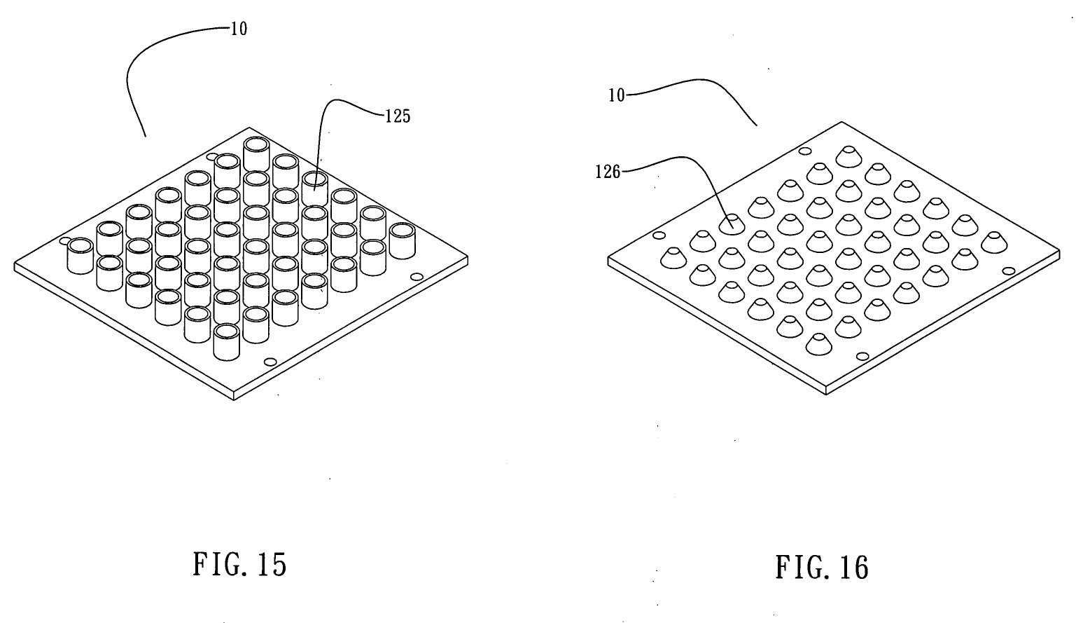

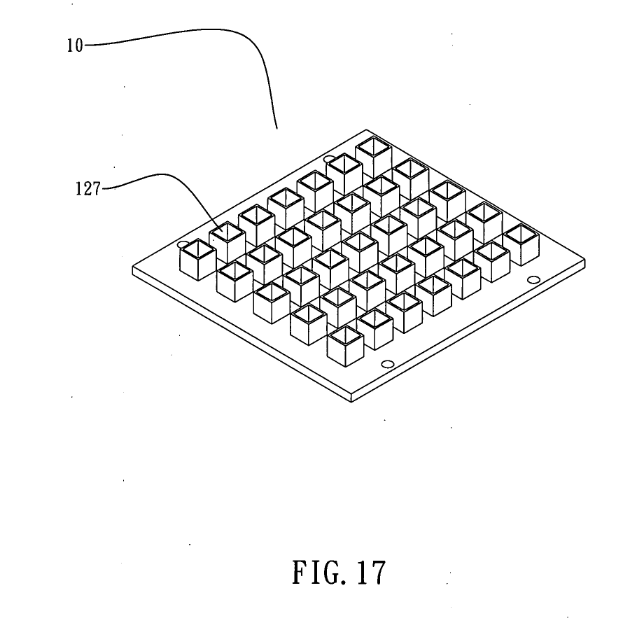

As shown in FIGS. 15-17, the cylindrical dissipating protrusions (121), cone-shaped dissipating protrusions (122), and the square-column-shaped dissipating protrusions (123) can be hollow.

Furthermore, the lamp mask of the ceramic radiator can be removed when it is placed indoors.

I claim:

1. A ceramic radiator with conductive circuit which rapidly absorbing and dissipating the heat of the LED lights being lightened uses the ceramic with high conductivity and high radiation physical characteristics to manufacture said one-body-shaped radiator, wherein said radiator has front side, back side and ends; a conductive circuit is set on said front side of said radiator to enable one or more LED lights installed thereon lightened; several sets of said heat sinks are installed on said back side and said ends to increase the efficiency of heat dissipating; a lamp mask covers said LED lights, said ceramic radiator may remove its lamp mask when placed indoors.

2. A ceramic radiator with conductive circuit as recited in claim 1, wherein said heat sinks may be only installed on said back side or one of said ends.

3. A ceramic radiator with conductive circuit as recited in claim 1 comprising with a frame with several retaining holes thereon, radiators, said LED lights, and said lamp mask, wherein install one radiator into each retaining hole respectively and allow each set of said heat sinks out of said retaining hole; install said LED lights on said conductive circuit at the bottom of said radiator to enable said LED lights receive the electric power to be lightened; said lamp mask covers each set of said LED lights to form a structure of plurality of radiators.

4. A ceramic radiator with conductive circuit as recited in claim 1 comprising with a ceramic cover, said LED lights, and said lamp mask, wherein many sets of heat sinks are prominent outwardly on top of said ceramic cover; a conductive circuit is set at the bottom, and said LED lights are installed on said conductive circuit to enable said LED lights receive the electric power through said conductive circuit to be lightened; said lamp mask covers each set of said LED lights; all LED lights and said masks are installed under said ceramic cover to form a single large structure.

5. A ceramic radiator with conductive circuit as recited in claim 1 comprising with a long-shaped radiator, said LED lights, and said lamp mask, wherein said long-shaped radiator is hollow inside, install heat sinks on each inside; a conductive circuit is set on each outside, and said LED lights are installed on said conductive circuit to enable said LED lights receive the electric power to be lightened, said lamp mask covers said LED lights.

6. A ceramic radiator with conductive circuit as recited in claim 1, 3, 4 or 5, wherein said radiator, said ceramic cover and said heat sinks on said long-shaped radiator can be cylindrical dissipating protrusions, cone-shaped dissipating protrusions, square-column-shaped dissipating protrusions or wavy dissipating protrusions.

7. A ceramic radiator with conductive circuit as recited in claim 6, wherein said cylindrical dissipating protrusions, said cone-shaped dissipating protrusions, and said square-column-shaped dissipating protrusions can be hollow.

8. A ceramic radiator with conductive circuit as recited in claim 6, wherein the area of heat dissipating on said radiator is wide enough, there is no need to install said heat sinks, said back side and said ends could be designed as smooth surfaces instead.
